(19) United States
(12) Patent Application Publication
(10) Pub. No.: US 2017/0357489 A1
(43) Pub. Date: Dec. 14, 2017

(54) SYSTEM AND METHOD FOR DEVELOPING APPLICATIONS

(71) Applicant: Jeff Fleurimond, Maplewood, NJ (US)

(72) Inventor: Jeff Fleurimond, Maplewood, NJ (US)

(21) Appl. No.: 15/618,932

(22) Filed: Jun. 9, 2017

Related U.S. Application Data
(60) Provisional application No. 62/348,128, filed on Jun. 9, 2016.

(51) Int. Cl. G06F 9/44; G06F 9/45; G06F 3/0484

(52) U.S. Cl. CPC G06F 8/34; G06F 8/43; G06F 3/0484

(57) ABSTRACT

A system and method for developing an application. The system comprises a user interface, an object module for creating an object comprising an attribute and a function returning a value for the attribute, an activity module for defining an object's behavior, a simulation module comprising a rule governing the object's environment, and a build module, for compiling the application. The method comprises the steps of defining a plurality of objects and a relationship between the objects, extrapolating a logical clause based on the relationship, and building an application consistent with the logical clause.

### FIELD OF THE INVENTION

In general, the present invention relates to systems and methods for developing applications. More specifically, the present invention is for systems and methods that are designed to enable individuals unfamiliar with computer-coding languages to develop computer and mobile game applications.

### BACKGROUND OF THE INVENTION

Creating applications traditionally requires developers to learn specific coding languages. The high learning curve prevents many from coding. There have been some attempts to simplify coding.

One method for simplifying coding is the use of macros, which can record a user's actions to execute later. This can be useful for automating repetitive processes but do not allow for the dynamic interactions required for many applications such as games.

Another method for simplifying coding is the use of templates, which allow users to define certain variables such as color and size. This enables users to customize applications to a limited degree. However, the basic framework and functions of the applications must be predetermined, limiting the user's ability to create unique applications.

In addition, to create similar, but not identical content, the user must create them from scratch or, at the very least, adjust the variables of existing content for each new content. For example, to create new levels in a game, the user would have to create them from scratch, which is very time consuming. Alternatively, the user can adjust the variables in existing levels to change their look and feel for new levels, which can be time-consuming and can limit the degree of variability. In either case, the user must test the new levels to gauge their difficulty, which is another time-consuming process.

There are no tools that enable users to create unique interactive applications with dynamic content without having to learn a coding language. In addition, there are no tools that enable auto-generation of new content.

Therefore, a need exists for a system and method designed to enable individuals unfamiliar with computer-coding languages to develop computer and mobile game applications.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present invention is a system and method that is designed to allow individuals unfamiliar with computer-coding languages to develop computer and mobile game applications. The system utilizes a robust user-interface and artificial-intelligence controlled code generation to facilitate cross-platform development of games and other applications.

The system software libraries compose front-end and back-end modules. Front-end modules collect and process data describing application functionality, using specialized mechanisms to better organize and interpret data. Back-end modules analyze data to customize and initialize systems required to implement application functionality, using key components to control process life-cycles.

### BRIEF DESCRIPTION OF THE DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a flow chart that outlines the system and operation of the present invention.

FIG. 2 is a visual representation of an artificial intelligence module of the present invention.

FIG. 3 is a flow chart that outlines the process of configuring a scenario.

FIG. 4 is a visual representation of a scenario.

FIG. 5 is a flow cart of an example of a scenario.

FIG. 6 is a visual representation of the parameters of the scenario of FIG. 5.

FIG. 7 is a visual representation of the relationships between the parameters of the scenario of FIG. 5 and functions.

FIG. 8 is a visual representation of the relationships of FIG. 7 and two difficulty scenarios.

FIG. 9 is a visual representation of a preference.

FIG. 10 is truth table of clauses.

FIG. 11 is a visual representation of two scenarios.

FIG. 12 is a visual representation of the scenarios of FIG. 11 and an interpolated scenario.

FIG. 13 is a flow chart of the interpolation process of FIG. 12.

FIG. 14 is a flow chart of the simulation process.

FIG. 15 is a flow chart that outlines the process of building a composite.

FIG. 16 is a visual representation of a composite.

FIG. 17 is a visual representation of another embodiment of the present invention.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION OF THE DRAWINGS

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left are used to describe the accompanying figures. The terminology includes the words above specifically mentioned, derivatives thereof, and words of similar import.

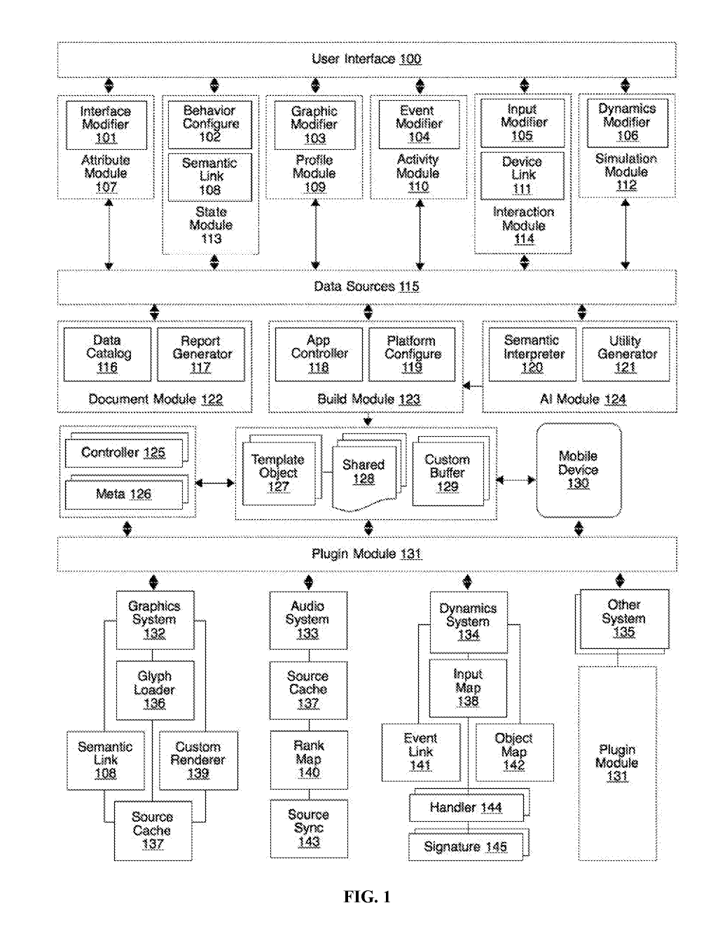

Referring to FIG. 1, a user interface 100 is provided to operate the software system. The user interface can be any machine, device, or process, providing functionality for communication between other machines, devices, and processes.

The software system has many aspects that are divided into various blocks for easier description and understanding. Blocks 101-114 each provide objects that may be preset, user-configurable, or entirely user created. These objects can be visual or audio objects, actions, conditionals, expressions, attributes, user actions, and states. For example, an object can be a game character, a character's movement, a character's ability, a player gesture such as a touchscreen swipe, or a state specifying a combination of aspects included but not limited to the before mentioned. Not all blocks are necessary, some blocks may be combined, and other blocks are possible in other embodiments.

Block 101 shows an interface modifier. The interface modifier is responsible for interpreting and managing object interface reference data.

Block 102 is a behavior configure. The behavior configure is responsible for object visual, audio, and response characteristics activation. Block 103 is a graphic modifier. The graphic modifier is responsible for interpreting and managing user data relative to graphics, “look and feel,” and audio. Block 104 is an event modifier. The event modifier is responsible for interpreting and managing user data relative to events, cyclic procedures, and actions. Block 105 is an input modifier. The input modifier is responsible for interpreting and managing user interface input data. Block 106 is a dynamics modifier. The dynamics modifier is responsible for interpreting and managing user dynamics data.

The interface modifier is a subcomponent of the attribute module 107. The attribute module 107 manages types, identifiers, and auxiliary components associated with an object. Types include but are not limited to alphanumeric elements and container-hybrid elements. Identifiers associate data with parameter access, allowing for value read/write or modification. Auxiliary components allow an object to integrate elements defined in another object.

Block 108 is a semantic link. The semantic link is responsible for managing semantic associations, linking data elements or data sources to specific reference identifiers. The semantic link and the behavior configure are subcomponents of the state module 113. The state module 113 manages a behavioral pattern through object trait activation. Subcomponents manage elements controlling an object's life-cycle within an environment. An object may modify parameters or choose to transition into other patterns. Pattern elements form a pseudo-template stored and tagged for use during initialization processes.

The state module 113 lets users configure objects that define an application entity's overall look and feel, and action-response mechanisms.

Users configure presentation layers and behavior patterns that can be linked to specific state objects. The objects function as attribute containers. They help users organize an entity's characteristics into manageable groups and assign each an identifier. The identifiers facilitate state-to-state interaction as well as the trigger mechanisms associated with each state.

Within each state object, references to a subset of the system attributes available for activation exists for configuration. This includes but is not limited to a number attributes that relate to an entity's overall appearance, interaction, and behavior within the game environment. A trigger configuration subsection is also available to reference action elements that help control entity behavior.

Users can also link custom parameters to specific states for initialization and update. A state object can enter a number of phases during an application's execution. A custom parameter can be assigned specific values during each phase of the state's life-cycle.

A variety of other configurable options are available to help drive entity presentation and behavior, included but not limited to active audio and visual components, active physics behavior and interaction, active device interface behavior, active parameter initialization, trigger actions, and trigger events.

Through the state configuration module, you can create and control every aspect of an entity's presentation layer i.e. the way it looks in the game as well as its behavior at any given time during a game application's run loop.

The graphic modifier is a subcomponent of the profile module 109. The profile module 109 manages audio and visual object traits. Configurable characteristics include but are not limited to appearance and acoustics parameters, file-referencing, and conversion mechanisms.

The event modifier is a subcomponent of the activity module 110. The activity module 110 manages actions, expressions, and conditional object traits. Expressions define evaluable statements containing numbers, symbols, and operators. Conditionals represent an aggregate value defined as an evaluation of an expression element, conditional element, or hybrid element. Actions initiate processes to execute a command series. Commands interact with various parameters and other elements to implement object behavior.

Block 111 is a device link. The device link 111 is responsible for linking and accessing device attributes. The device link 111 and the input modifier are subcomponents of the interaction module 114. The interaction module 114 manages object device-interaction behavior. The module 114 processes action-response links, allowing for device component analysis including gesture and accelerometer analysis, through specialized input mechanisms.

The dynamic modifier 106 is a subcomponent of the simulation module 112. The simulator module 112 manages object behavior within a simulated environment. Configurable attributes include but not limited to physics relative parameters, collision-response mechanisms, and constraints.

The attribute module 107, state module 113, profile module 109, activity module 110, interaction module 114 and simulation module 112 communicate with data sources 115. The data sources 115 include but not limited to various databases, both internal and external.

Referring to FIG. 17, some of these modules can be combined. For example, the attribute module 107, activity module 110, and relations module 49 can be combined into an object module 50 and the interaction module 114, simulation module 112, profile module 109 can be included in the state module 113.

The data sources 115 communicates with a document module 122, a build module 123 and an artificial intelligence (“AI”) module 124. The document module 122 manages project data relative to specification, tracking, scheduling, and reporting.

The document module 122 manages project data relative to specification, tracking, scheduling, and reporting. The document module 122 contains a data catalog 116 and a report generator 117. The data catalog 116 manages data descriptors and other information types to facilitate the documentation process. The report generator 117 manages reporting tools and Meta data. Reporting tools process the meta data to produce and present analytical information relative to a project.

The build module 123 contains an application controller 118 and a platform configure 119. The build module 123 manages project application code to be deployed to a device. Data is tagged, queried, and used to construct structures required to build project application functionality. Structures are aggregated to file and copied to a target device or machine for launch during a deployment phase. The application controller 118 manages platform project integration. Platforms vary in operation and functionality. The process identifies and implements integration hooks to facilitate application/platform communication. The platform configure 119 manages platform environment configuration. The target environment is determined through device queries and other system specific parameters. The configuration is derived from an environment analysis and helps to produce cross-platform executable files.

The AI module 124 contains semantic interpreter 120 and utility generator 121 subcomponents. The AI module 124 manages configurations to control utility agent behavior. The configurations associated with the agent can be adjusted to influence the analysis task. The agent analyzes data to generate code to build a unique execution path, building a unique user experience. The process allows for multiple code versions to derive from a single source. The semantic interpreter 120 manages data relative to heuristic semantic interpretation. The data associates various components to semantic identifiers. The Identifiers are used during agent processing to access elements assigned a specific meaning. Associations linked to the semantics are implemented in the agent's functionality. The utility generator 121 manages performance measure data used to govern agent processes. The data also helps identify important elements ranked according to desirability. The elements are tracked, mapped, and queried to facilitate path execution selection.

In game development, the AI module 124 automates the process of level design. In a normal situation, a developer would build the game objects needed for an application. Then, for every level planned, the developer would have to arrange the participating objects in their proper locations within the level and configure their behavior to deliver the desired effect. The AI module 124 automates this process, significantly cutting development time.

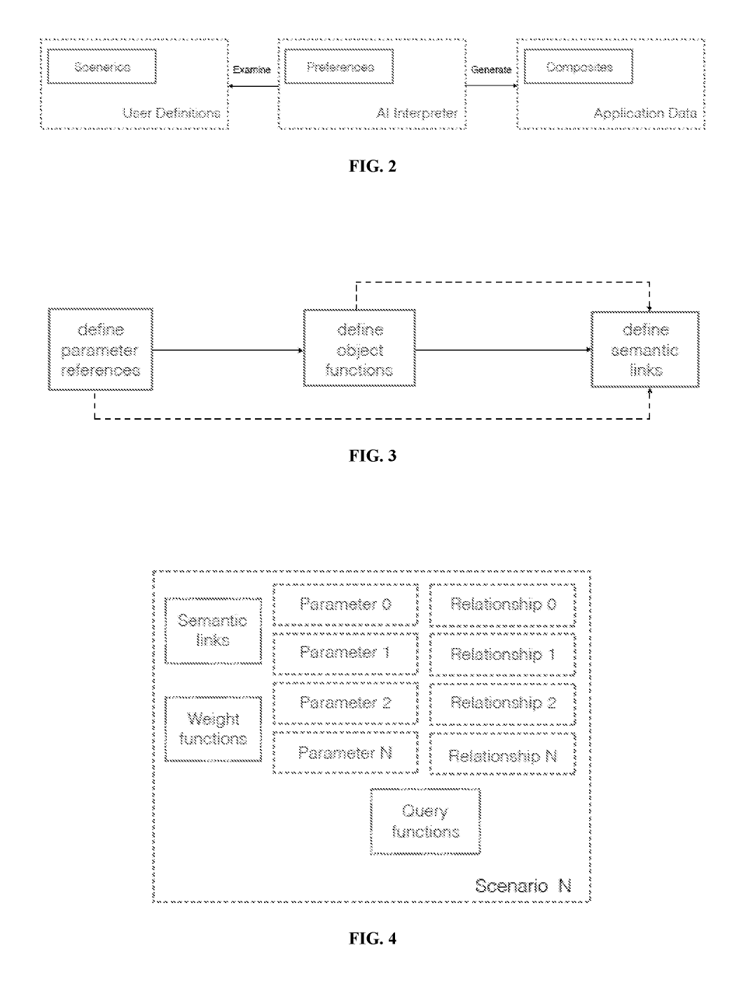

Referring to FIG. 2, the AI module 124 process can be divided into three parts: user definitions containing scenarios, an artificial intelligence interpreter containing preferences, and application data containing composites.

The AI module 124 examines user-defined scenarios to build a knowledge base that will be used to create composite data.

Referring to FIG. 3, to configure a scenario, first, the user defines parameter references in order to communicate to the AI module 124 the objects that will be modified. Parameters define references used in all AI module 124 operations. The references resolve to type-dependent values that describe objects and the relationships between them. As shown in FIG. 17, a separate relations module 49 can be used or it can incorporated into other modules such as the object module 50.

Next, functions are defined to register with the AI module 124 the names of the operators that will work with parameter data. Lastly, semantic links are defined to establish the context meaning of data, i.e., interpretation of the data.

Referring to FIG. 4, a scenario is a possible situation within the game that the user wants the AI module 124 to learn about. The AI module 124 analyzes this scenario and derives an understanding about how the objects behave and what affects their behavior might have. With this knowledge, the AI module 124 will be able to construct alternate versions of these scenarios for a level.

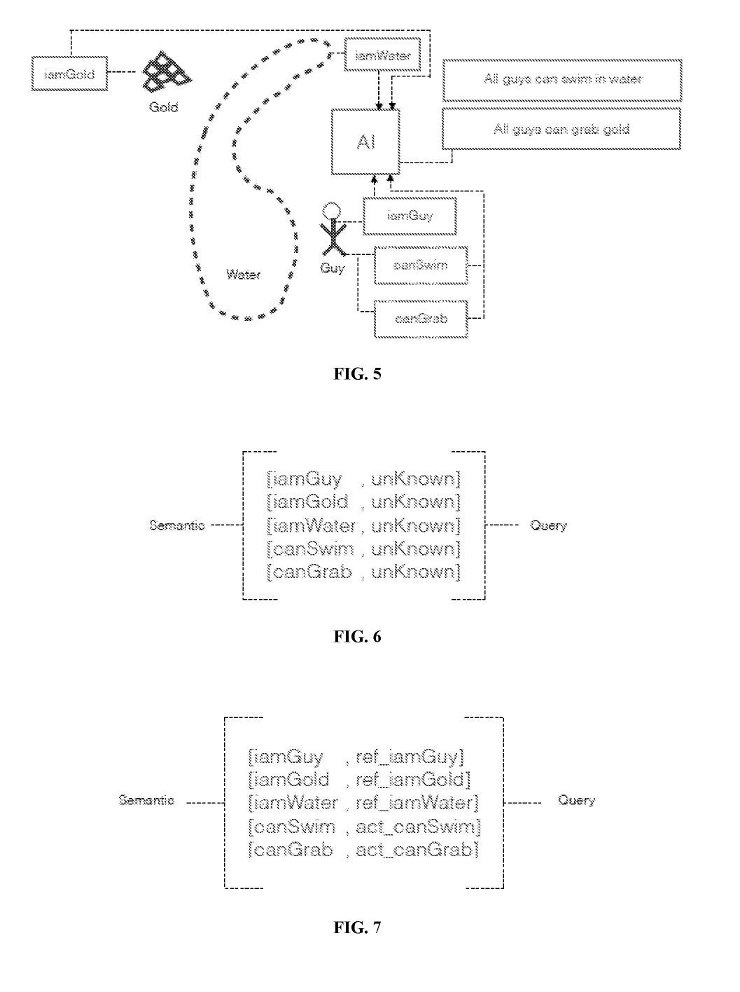

Referring to FIG. 5, in an exemplary scenario, the scenario has objects named “Guy,” “Gold,” and “Water.” All objects know their type “iamGuy,” “iamGold,” and “iamWater,” respectively. The “Guy” object knows he “canGrab” and “canSwim.”

Referring to FIG. 6, the scenario is defined by creating parameters “iamGuy,” “iamGold,” and “iamWater” and relationships “canSwim” and “canGrab” through the interface. The AI requires knowledge about how to resolve the semantic link elements in configuration. Query functions help the AI find out information about the object referenced.

The query functions examine parameters and relationships to produce a result that the AI can interpret. The format of the result is dependent on how the user defines the function, the parameter type or, in the case of a relationship, the parameter type of the relationship.

In FIG. 7, the functions “ref_iamGuy(chk_guy),” “ref_iamGold(chk_gold),” “ref_iamWater(chk_water),” “act_canSwim(swimmer,swim_in),” and “act_canGrab(grabber,grab_it)” are added and linked to the appropriate semantics. This tells the AI which function to use to query any of the referenced objects denoted by semantic.

“iamGuy,” “iamGold,” and “iamWater” are configured as parameters and treated like properties. While “canSwim” and “canGrab” are configured as relationships. Relationships define a relation between two objects. In this example, the relationship “canSwim” is the function act_canSwim(swimmer, swim_in).

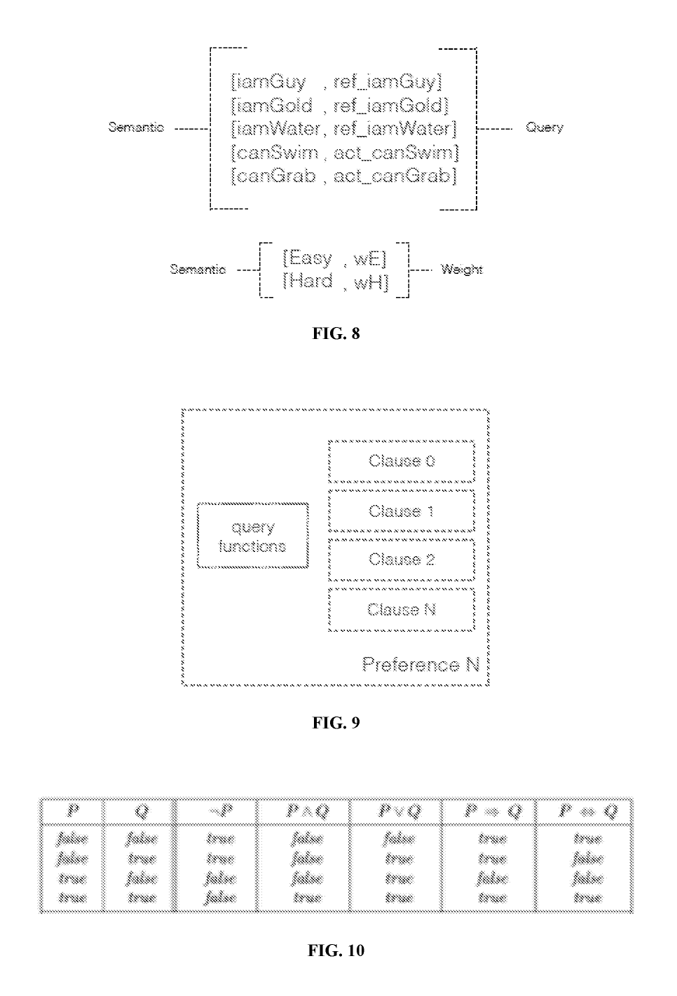

Referring to FIG. 8, weight function data is added. Weight functions allow comparisons between scenarios to take place. A user defines a procedure using the interface that produces a value representative of how the AI should view grouped components as a whole. In the example, the difference between “Easy” and “Hard” is defined. The function is entirely dependent on a single parameter but it does not have to be. Once defined, it is used to order scenarios according to desirability.

Referring to FIG. 9, the AI derives preference data from analyzing the scenario data referenced in FIG. 4. The AI examines the defined elements and constructs the clauses using the data and query functions that drive its own behavior.

Clauses govern the behavior of the AI during level construction. When the AI is executing a task that requires decision-making, it queries the clauses to determine the correct course of action. The clauses represent the logic that the AI follows to deliver what it determines the user wants. The result of the query can vary. It can be simple data or complex, e.g., a list, tree, graph or custom structure. The AI resolves the result of the query to a value that allows it make a decision.

Referring to FIG. 8, the query functions will take the terms, perform a user-defined operation upon them, and return details that the AI will interpret to construct or resolve a logic statement or clause. The queries have been defined as follows: “ref_iamGuy” returns “true” for “guy,” “ref_iamGold” returns “true” for “gold,” “ref_iamWater” returns “true” for “water,” “act_canSwim” returns “true” for (guy, water) relationship, and “act_canGrab” returns “true” for (guy, gold) relationship.

Referring to FIG. 10, combining the information from the configuration, the AI derives two clauses to add to its knowledge base: “All guys can swim_in water” and “all guys can grab the gold.” Now, the AI understands everything that is required for it to build a composite with this scenario. If the AI wishes to add a version of this composite to a level, it will know exactly how the gameplay will be altered via the clauses and environment, e.g., how the gameplay will be altered by a new object added to environment.

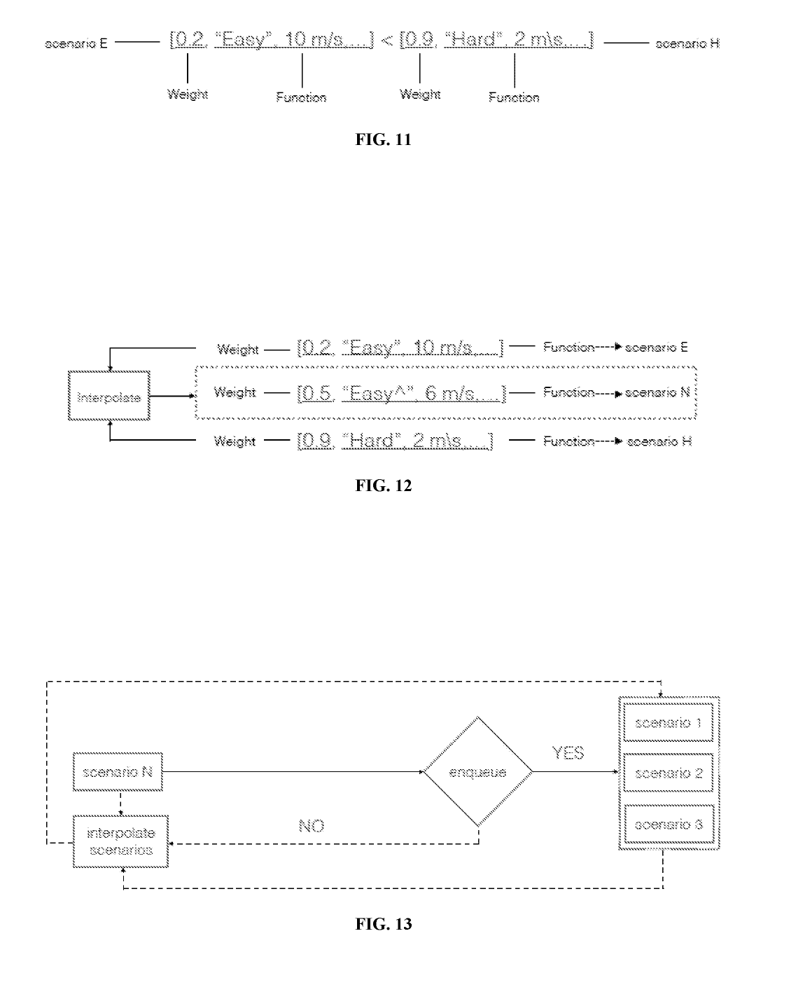

Referring to FIG. 11, the weight function returns a result in the interval [0.0, 1.0] and the query function returns a value of 2 m/s or 10 m/s, and both components are linked to a semantic function holding a value of either “Easy” or “Hard,” respectively. A parameter named “swimSpeed” is also defined.

The AI will determine that “scenario H” is more difficult than “scenario E” and if its goal is to build an easy level, then a comparison between “scenario E” and “scenario H” will yield a result that will lead to “scenario E” being chosen for inclusion.

The AI will add “scenario E” to the level. Internally, the clauses created in the AI's knowledge base will be akin to “Swimming with speed at 10 m/s is Easy,” “scenario E is Easy,” “Swimming with speed at 2 m/s is Hard,” and “scenario H is Hard.”

In practice, multiple scenarios are chosen to be included in a level. The AI only adds scenarios it believes will help deliver the experience it thinks the user wants. If the user wants a hard game or an easy game, all scenarios as a whole must deliver that experience. At times, this may not be a straight forward add operation; some adjustments may need to be made to a scenario in order for it to fit properly in the context of a level and be in balance with the rest of the game.

Referring to FIG. 12, the AI chooses three scenarios to add to a level, intended to be moderately difficult. Let “scenario E” and “scenario H” be defined as “Easy” and “Hard,” respectively, through weight and semantic functions. Adding either state may not yield the type of experience the AI is trying to achieve because if either of them are added, it will cause an imbalance in the level's gameplay. As a result, the AI must interpolate between the scenarios, producing a new scenario “scenario N” to be added to the set.

Specifically, we assume a parameter named “swim Speed” with possible value of either 2 m/s or 10 m/s has been defined for “scenario E” and “scenario H.”

Referring to FIG. 13, assuming an enqueue has failed, the AI averages the total weights involved and uses the value to perform the interpolation.

Given an average weight of 0.5, the process will assign “swimSpeed” 6 m/s. All numerical values for the participating parameters would be adjusted in this manner and all other types of values would be adjusted according to type, to produce the new “scenario N” for inclusion.

Scenarios define the specifics of a composite, whether it be a boulder rolling at a high speed or a character with the option to go out for a swim. The AI understands the mechanics of these scenarios and can build their behavior into the overall gameplay of a level.

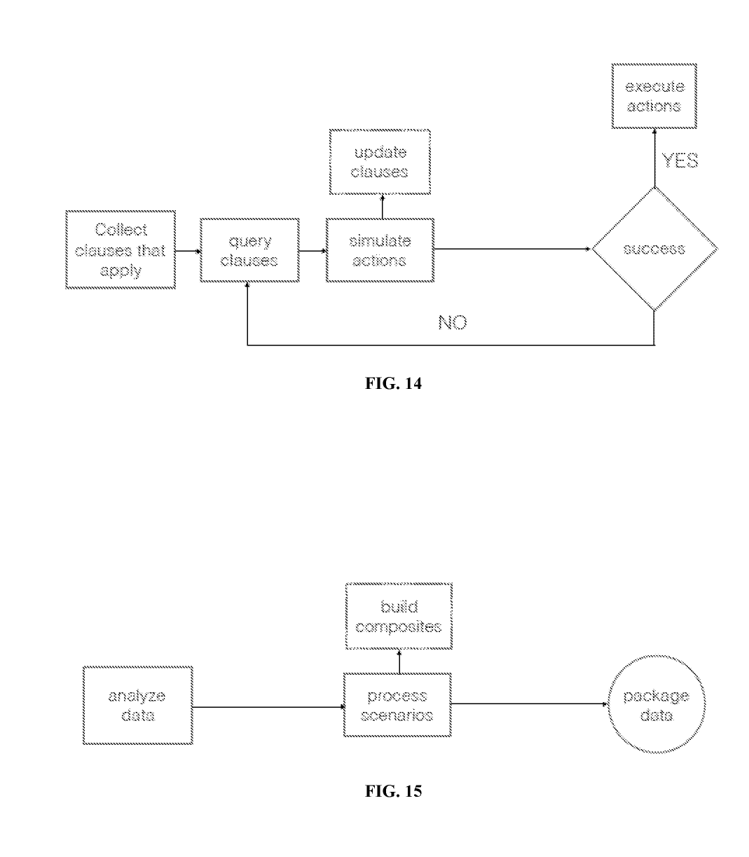

Referring to FIG. 14, next, the AI uses reasoning and simulation to determine whether gameplay provides a valid path to victory. The first step in the process is for the AI to scan all of the related clauses of the scenarios it plans to use for gameplay. Second, it will create the environment to test the behavior of the composite. During this step, the AI will mimic a human player and use its knowledge about the world, contained in the clauses, to accomplish the victory conditions defined by the user. After the queries conclude the AI player will simulate a set of actions. Then, it will update the clauses to reflect the change, if any, in the environment. Successfully affecting the environment or satisfying a pre-defined victory condition will adjust the test. Otherwise, the AI player will restart the process from step “query clauses.”

The process is expected to yield different results as the testing continues because the queried clauses are always updated regardless of the outcome of simulated actions. This way every iteration of the process will have new knowledge to improve the AI player's chances of success.

Referring to FIG. 15, the AI builds composite data from the knowledge base constructed from the inspection of user-defined scenarios. An analysis of the data is done to gain knowledge about the different objects available for inclusion in an application and its associated preferences. The preferences are processed, i.e., scenarios and composite data is created. The data is later packaged for distribution.

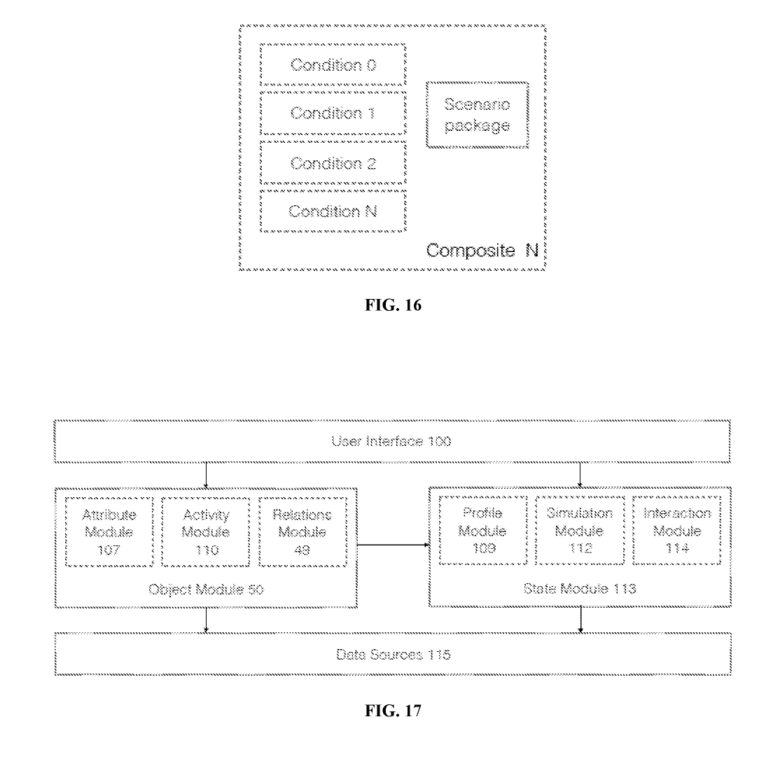

Referring to FIG. 16, the conditionals in the composite drive its behavior. For example, given an object in the environment, if this object is positioned in the pathway of a rolling rock, a “Condition 0” in “Composite N” may be “on impact return true.” The satisfying of this “Condition 0” and subsequent “Condition N” represents the satisfying of the entire “Composite N.” The satisfying of N conditionals is a victory.

The scenarios in a composite have a physical world component, complete with objects and behavior, where the conditions apply. For example, referring to FIG. 4, the environment contains a pile of gold, a body of water, and a character who could grab gold and swim_in water. Converting this environment into a composite would be simple, requiring the creation of a single “Condition 0” to exists stating “when guy grabs gold return true” and a package containing the physical objects representing the environment. In practice, this composite, if the only one in the final distribution, would represent a game with a single level, where victory is guy grabbing the gold.

The AI would repeat the process above to build composites based on user-preferences. Each composite would create an environment and a list of conditionals that a potential player must satisfy in order to “win.”

Referring to FIG. 1, controllers 125 handle pipeline-segments processing meta data 126. The controllers 125 centralize and govern sub-structures responsible for data manipulation.

Meta data 126 is the core data queried, updated, and processed through controller member pipeline segments.

Template object 127 serve as manager containers for specific data types. Data is initialized through the object and managed by the object.

Shared data 128 is treated as a system resource and is managed through mechanisms designed to reduce memory consumption.

Custom buffer 129 serve as containers with specialized components allowing a custom process to be executed through an interface.

The system can interact with any mobile device 130. The mobile device 130 can be any machine or device consisting of at least one central processing unit and some form of memory.

A plugin module 131 is provided to enable pipeline-process extension or modification. It processes data from the controller 125, meta data 126, template object 127, shared data 128, custom buffer 129 and the mobile device 130.

A graphic subsystem 132 is provided for managing processes relative to graphics functionality, including image processing, texturing, and vertex data rendering and manipulation. The graphic subsystem communicates with a glyph loader 136 that can manage font image-processing mechanisms associated with a graphics system. A glyph rendering sub-procedure handles font processing. The procedure uses specialized algorithms to organize, cache, and access glyph information. The graphics subsystem 132 communicates with the semantic link 108 and a custom renderer 139. The custom renderer 139 manages the rendering procedures associated with a graphics sub-system. Graphics capabilities depend on software, hardware, and other system components. The process mediates the access between the variable resources through a specialized interface. The semantic link 108, custom renderer 139 and glyph loader 136 all communicate with a source cache 137. The source cache manages source data relative to a sub-system. Source data queued for processing in the pipeline require component activation. The process facilitates the activation mechanism through a specialized caching procedure, reducing the execution time.

An audio subsystem 133 also communicates with the plugin module 131. The audio subsystem manages processes relative to audio functionality, including audio sampling, playback, and modification. The audio subsystem 133 communicates with the source cache 137. A rank map 140 provides a ranking system that is used to facilitate audio playback. System dependent resources are finite. A ranking procedure allows priority to be assigned to specific sources to guarantee processing during low-resource availability. A source synchronization 143 manages resource access for source data audio playback. Source data queued for processing require access to system dependent resources. A sync process links a resource to a source to initiate the playback mechanism.

A dynamics system 134 communicates with the plugin module 131. The dynamics system 134 manages processes relative to dynamics functionality, including physics, input and response, collision and response, and constraints. The dynamics system 134 uses data from an input map 138. The input map manages input-mapping and input-linking mechanisms associated with a dynamics sub-system. Hardware input interfaces will vary between devices and machines. The process handles linking between hardware-supported inputs and customizable handlers to facilitate the event-response process.

An event link 141 manages and tracks observable events for dynamics relative subcomponents. Event types vary between platforms. The process allows for custom events to be integrated into a dynamics system. An object map 142 manages object mappings relative to an event-response system. Objects require an associated handler to facilitate dynamics operation in a simulated environment. The mapping is queried during an event and the linked handler processes the event data. A handler 144 initiates customizable procedures through a specified interface. Handlers 144 serve as delegates to extend process functionality relative to an event-response system.

A signature subsystem 145 manages input and event tracking, and gesture recognition procedures associated with a dynamics sub-system. Specialized components help define input and event patterns. The process queries the patterns through a sub-system, processing data as matches are discovered.

Other systems 135 can communicate with the plugin module 131. The other system 135 can manage processes relative to customizable pipeline functionality, including processes, modules, templates, controllers, and data types.

The present invention may be embodied in other specific forms without departing from its spirit or essential characteristics. The described embodiments are to be considered in all respects only as illustrative and not restrictive. The scope of the invention will be, therefore, indicated by claims rather than by the foregoing description. All changes, which come within the meaning and range of equivalency of the claims, are to be embraced within their scope.

1-10. (canceled)

11. A system for developing an application, comprising:
a user interface;
an object module, capable of creating an object comprising an attribute and a function returning a value for the attribute using the user interface;
an activity module, capable of defining the object's behavior, using the user interface;
a simulation module, comprising a rule governing the object's environment; and
a build module, capable of compiling the application.

12. The system of claim 11, wherein the object, object behavior, and rule are preset, user-configurable, or user created.

13. The system of claim 11, wherein the object is a visual object, an audio object, an action, a conditional, an expression, an attribute, a user action, or a state.

14. The system of claim 11, wherein the object is a game element, an instance of the game element, or a user interaction.

15. The system of claim 11, further comprising:
a relationship module, capable of creating functions returning a value for a relationship between objects, between object behaviors, or between an object and an object behavior.

16. The system of claim 15, further comprising:
an artificial intelligence module;
a plurality of scenarios, each comprising a unique value for at least one variable;
wherein the artificial intelligence module is capable of extrapolating a logical clause from the relationship; and
wherein the artificial intelligence module is capable of creating a scenario interpolated from the plurality of scenarios.

17. The system of claim 16, wherein the artificial intelligence module is capable of extrapolating logical clauses from a truth table comprising permutations of the relationships.

18. A method of developing an application, comprising the steps of:
creating a relationship between objects; and
compiling the objects and the relationship.

19. The method of claim 18, wherein at least one of the objects is a user interaction.

20. The method of claim 18, wherein the step of compiling further comprises creating a first scenario comprising objects and relationships.

21. The method of claim 20, further comprising the step of automatically extrapolating a second scenario by altering a variable in the first scenario.

22. A method of automating application development, comprising the steps of:
a user defining a scenario, comprising a plurality of objects and a relationship between the objects;
a computer extrapolating a first logical clause based on the relationship; and
the computer building an application consistent with the first logical clause.

23. The method of claim 22, wherein the first logical clause is extrapolated from a truth table comprising the relationship.

24. The method of claim 22, wherein the user defines a plurality of scenarios and a new scenario is interpolated.

25. The method of claim 22, wherein the user selects a parameter to modify and wherein a new scenario with a modified parameter is generated.

26. The method of claim 22, wherein the application is executed with a simulated user and wherein an outcome is recorded.

27. The method of claim 26, wherein a second logical clause is extrapolated from the outcome and wherein the method is iterated with the building of the application consistent with the first and second logical clauses.

28. The method of claim 25, wherein the user defines a numerical range for the parameter and the new scenario is generated with the parameter modified to a value within the numerical range.

29. The method of claim 28, wherein the user assigns numerical weights to minimum and maximum values of the numerical range and weights of intermediate values are extrapolated.

30. The method of claim 28, wherein the user selects a plurality of parameters to modify and wherein weights of the values of the parameters are averaged for an average weight and the new scenario is generated with the average weight.
